(19) United States
(12) Patent Application Publication
(10) Pub. No.: US 2019/0020734 A1
(43) Pub. Date: Jan. 17, 2019

(54) REDUCED CONTENT MANIFEST SIZE

(71) Applicant: COMCAST CABLE COMMUNICATIONS, LLC, Philadelphia, PA (US)

(72) Inventors: Alexander Giladi, Princeton, NJ (US); Yasser F. Syed, La Crescenta, CA (US)

(21) Appl. No.: 16/036,561

(22) Filed: Jul. 16, 2018

Related U.S. Application Data
(60) Provisional application No. 62/532,836, filed on Jul. 14, 2017.

(51) Int. Cl. H04L 29/06; H04L 29/12

(52) U.S. Cl. CPC H04L 69/04; H04L 61/3015; H04L 61/1582; H04L 65/4069; H04L 65/1089; H04L 65/607

(57) ABSTRACT

Disclosed are systems and methods for manifest file size reductions. It can be determined that one or more segments of a representation of a content item are unavailable. A manifest can be generated comprising a representation element indicating the unavailable one or more segments. The representation element can include a text string associated with content displayable instead of the unavailable one or more segments.

### CROSS REFERENCE TO RELATED APPLICATION

This application claims priority to U.S. Provisional Patent Application No. 62/532,836 filed Jul. 14, 2017, which is hereby incorporated by reference in its entirety.

### BACKGROUND

Manifest files facilitate access to content by user devices. The manifest files can include Uniform Resource Locators (URLs) and other parameters that allow the user devices to generate requests for segments of a content item. Some implementations of content delivery require that segments of the content item have unique, unpredictable names. Additionally, segments of the content item may be unavailable. These circumstances can cause an increase in manifest size due to the additional data required to describe these circumstances. These and other shortcomings are addressed by the approaches set forth herein.

### SUMMARY

It is to be understood that both the following general description and the following detailed description are exemplary and explanatory only and are not restrictive. Provided are methods and systems for reducing the size of a manifest file that facilitates access to content by a user device. A content item can correspond to a plurality of representations of the content item, each varying across bit rate, format, or other parameters. For each of the plurality of representations, a respective plurality of segments can be generated. It can be determined that at least one segment is unavailable. If so, a manifest file can be generated with a plurality of representation elements corresponding to the plurality of representations, with the representation element corresponding to the one of the representations associated with the at least one segment indicating that the at least one segment is unavailable. The manifest file can then be transmitted to a user device. This allows for a reduced size manifest to be transmitted to the user device, thereby saving network bandwidth and storage space of the user device when compared to existing solutions.

Alternatively, or in addition, it can be determined that at least a portion of one of a plurality of representations of a content item was not received, e.g., by a packager or edge device. If so, a manifest file can be generated with a plurality of representation elements corresponding to the plurality of representations, with the representation element corresponding to the one of the plurality of representations indicating that the at least the portion of the one of the plurality of representations was not received. The manifest file can then be transmitted to a user device.

A plurality of representations of a content item can be received, e.g., by a packager or edge device. A manifest file can be generated based on the plurality of representations, wherein the manifest file comprises a template element. The template element can comprise a plurality of segment elements, each comprising a respective sequential identifier and a respective string value. The manifest file can be transmitted to the user device. The user device can use the manifest file to formulate a request for a segment utilizing the respective sequential identifier and the respective string value. This use of the respective string value allows for segments to be named using non-predictable naming conventions, while reducing the manifest file size when compared to existing approaches. This saves in network bandwidth used for manifest file transmission, and reduces resources used by user devices to store and parse the manifest file.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of a content delivery network;

FIG. 2 is an example manifest file;

FIG. 3 is a flowchart of an example method;

FIG. 4 is a flowchart of an example method;

FIG. 5 is a flowchart of an example method; and

FIG. 6 is a block diagram of an example computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

In various instances, this detailed description may refer to content items (which may also be referred to as “content,” “content data,” “content information,” “content asset,” “multimedia asset data file,” or simply “data” or “information”). In some instances, content items can comprise any information or data that may be licensed to one or more individuals (or other entities, such as business or group). In various embodiments, content may include electronic representations of video, audio, text and/or graphics, which may include but is not limited to electronic representations of videos, movies, or other multimedia, which may include but is not limited to data files adhering to MPEG2, MPEG, MPEG4 UHD, HDR, 4k, Adobe® Flash® Video (.FLV) format or some other video file format whether such format is presently known or developed in the future. In various embodiments, the content items described herein may include electronic representations of music, spoken words, or other audio, which may include but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP), Sound Document (.ASND) format or some other format configured to store electronic audio whether such format is presently known or developed in the future. In some cases, content may include data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. In some embodiments, content items may include any combination of the above-described examples.

In various instances, this detailed disclosure may refer to consuming content or to the consumption of content, which may also be referred to as “accessing” content, “providing” content, “viewing” content. “listening” to content, “rendering” content, or “playing” content, among other things. In some cases, the particular term utilized may be dependent on the context in which it is used. For example, consuming video may also be referred to as viewing or playing the video. In another example, consuming audio may also be referred to as listening to or playing the audio.

Note that in various instances this detailed disclosure may refer to a given entity performing some action. It should be understood that this language may in some cases mean that a system (e.g., a computer) owned and/or controlled by the given entity is actually performing the action.

The present disclosure relates to reducing the size of manifest files used to facilitate access to content by user devices. A given content item can correspond to multiple representations. Each representation is a version of the same content item (e.g., the same movie or episode of a television show), but varying in format, bitrate, combinations thereof, and the like. Additionally, each representation can be divided into segments (e.g., one second of content, two seconds of content). A manifest file can be generated that describes each representation and includes parameters (e.g., Uniform Resource Locators (URLs), identifiers) used by the user device to generate requests for segments. The manifest file can be encoded as a tree of elements (e.g., one or more parent or high-level elements, each of which may include one or more child or lower-level elements) using Extensible Markup Language (XML) or another format.

Sometimes a segment of a particular representation of the content item may be unavailable for transmission to the user device. For example, a portion of the particular representation that would have been included in the segment may not have been received (e.g., one or more packets may have been dropped). The manifest file should indicate, to the user device, that this segment is unavailable. In existing solutions, the manifest file indicates these unavailable segments using separated higher level elements. For example, a Period element can describe a particular duration within a content item (e.g., a start time and an end time). Representation elements, encoded as children of the Period element, can describe each representation available during that duration. Thus, to indicate that a particular segment is missing for a given representation, a manifest file can include a separate Period element for the duration of the content item corresponding to the missing segment. This separate Period element would exclude the representation associated with the missing segment. For example, given one unavailable segment for a given representation, the manifest file would include a first Period element (corresponding to a duration of the content item before the unavailable segment) with Representation elements for all representations of the content item, a second Period element (corresponding to the duration of the unavailable segment) with Representation elements for all representations other than the representation corresponding to the unavailable segment, and a third Period element (corresponding to the duration after the unavailable segment) with Representation elements for all representations. If additional segments are unavailable, the manifest file would require further separation of the Period elements.

This approach requires multiple higher-level (e.g., Period) elements, each of which must include its own set of lower-level (e.g., Representation) elements. As the attributes described in the Representation elements are unchanged across Period elements, the manifest file will include multiple instances of identical Representation elements. This approach is inefficient due to the repeated instances of identical data and the overall increased manifest file size.

To overcome this increase in manifest file size, an additional attribute can be added to the Representation elements indicating which segments, for that particular representation, are unavailable. The attribute can be encoded as an attribute for the Representation element, or as a child element to the Representation element. Thus, the manifest file need not include multiple Period elements to indicate unavailable segments, thereby not needing for the inclusion and repetition of Representation elements for each Period element. This reduces the overall file size of the manifest file, and saves on network traffic used to transmit manifest files.

An additional challenge to manifest file size occurs when the file names of segments should follow a non-predictable naming convention. For example, a content deliverer may wish for segments to have file names that are not easily predictable to prevent a malicious party to generate requests for content segments. This can preclude a manifest file from including a Template element, which describes a standard naming convention for segments from which a user device can generate requests. Instead, existing solutions require that, for each representation, each segment must be individually identified. Thus, for M representations each having N segments, the manifest file must list M*N segment identifiers. To address this large file size of the manifest file, a SegmentTimeline can be used. The SegmentTimeline can include a plurality of segment elements (hereinafter referred to as S elements), each of whose attributes are applicable to all representations for the corresponding segment. For example, the S element for segment number 5 would include attributes that can be used by a user device to generate a request for segment number 5 for any available representation. The S elements can include an attribute, e.g., a random or unique string, that can be included in the file name of the corresponding segments. For example, a segment can be named according to the convention “segment_N_ID_STRING,” where N is a segment number, ID is a representation identifier, and STRING is the string attribute from the corresponding S element. This allows for an element of randomness or uniqueness to be included in the segment file names, thereby deviating from a predictable file naming convention, while not requiring an explicit recitation of each segment across all representations in the manifest file.

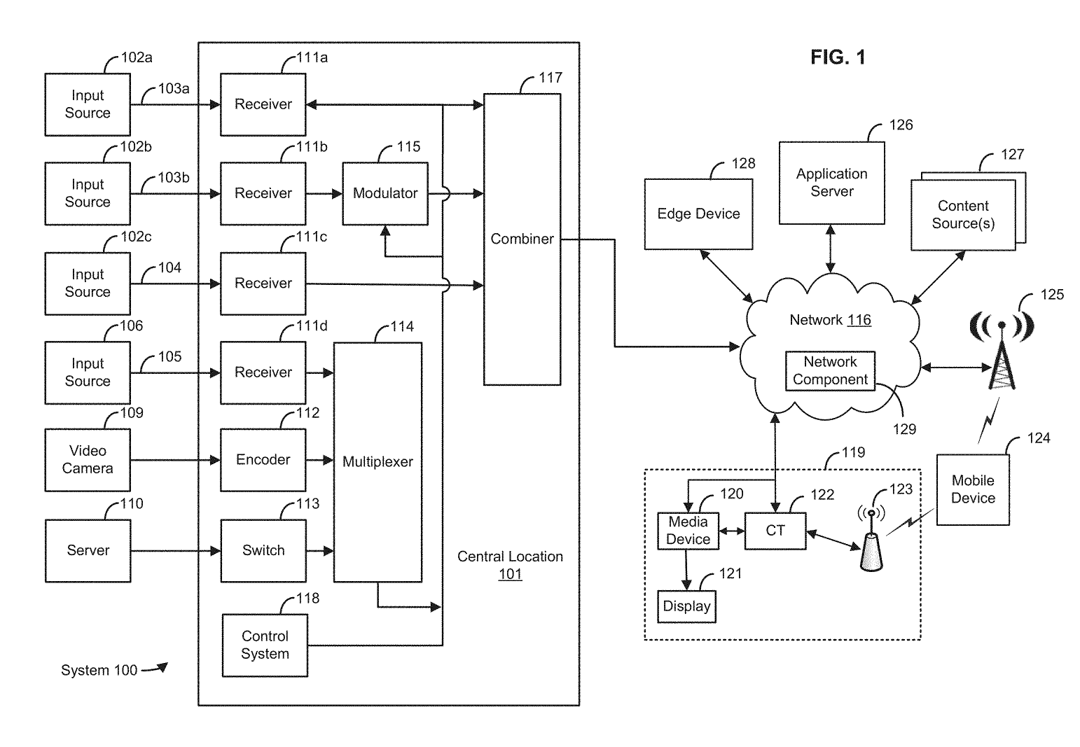

FIG. 1 illustrates various aspects of a system in which the present methods and systems can operate. Those skilled in the art will appreciate that present methods may be used in systems that employ both digital and analog equipment. One skilled in the art will appreciate that provided herein is a functional description and that the respective functions can be performed by software, hardware, or a combination of software and hardware.

A system 100 can comprise a central location 101 (e.g., a headend), which can receive content (e.g., data, input programming, and the like) from multiple sources. The central location 101 can combine the content from the various sources and can distribute the content to user (e.g., subscriber) locations (e.g., location 119) via a distribution system 116.

The central location 101 can receive content from a variety of sources 102a, 102b, 102c. The content can be transmitted from the source to the central location 101 via a variety of transmission paths, including wireless (e.g. satellite paths 103a, 103b) and a terrestrial path 104. The central location 101 can also receive content from a direct feed source 106 via a direct line 105. Other input sources can comprise capture devices such as a video camera 109 or a server 110. The signals provided by the content sources can include a single content item or a multiplex that includes several content items.

The central location 101 can comprise one or a plurality of receivers 111a, 111b, 111c, 111d that are each associated with an input source. For example, MPEG encoders such as an encoder 112, are included for encoding local content or a video camera 109 feed. A switch 113 can provide access to the server 110, which can be a Pay-Per-View server, a data server, an Internet router, a network system, a phone system, and the like. Some signals may require additional processing, such as signal multiplexing, prior to being modulated, Such multiplexing can be performed by a multiplexer (mux) 114.

The central location 101 can comprise one or a plurality of modulators 115 for interfacing to a network 116. The modulators 115 can convert the received content into a. modulated output signal suitable for transmission over a network 116. The output signals from the modulators 115 can be combined, using equipment such as a combiner 117, for input into the network 116. The network 116 can comprise a content delivery network, a content access network, and/or the like. For example, the network 116 can be configured to provide content from a variety of sources using a variety of network paths, protocols, devices, and/or the like. The content delivery network and/or content access network can be managed (e.g., deployed, serviced) by a content provider, a service provider, and/or the like.

A control system 118 can permit a system operator to control and monitor the functions and performance of the system 100. The control system 118 can interface, monitor, and/or control a variety of functions, including, but not limited to, the channel lineup for the television system, billing for each user, conditional access for content distributed to users, and the like. The control system 118 can provide input to the modulators for setting operating parameters, such as system specific MPEG table packet organization or conditional access information. The control system 118 can be located at the central location 101 or at a remote location.

The network 116 can distribute signals from the central location 101 to user locations, such as a user location 119. The network 116 can comprise an optical fiber network, a coaxial cable network, a hybrid fiber-coaxial network, a wireless network, a satellite system, a direct broadcast system, an Ethernet network, a high-definition multimedia interface network, universal serial bus network, or any combination thereof.

A multitude of users can be connected to the network 116 at one or more of the user locations. At the user location 119, a media device 120 can demodulate and/or decode, if needed, the signals for display on a display device 121, such as on a television set (TV) or a computer monitor. For example, the media device 120 can comprise a demodulator, decoder, frequency tuner, and/or the like. The media device 120 can be directly connected to the network (e.g., for communications via in-band and/or out-of-band signals of a content delivery network) and/or connected to the network 116 via a communication terminal 122 (e.g., for communications via a packet switched network). The media device 120 can comprise a set-top box, a digital streaming device, a gaming device, a media storage device, a digital recording device, a combination thereof, and/or the like. The media device 120 can comprise one or more applications, such as content viewers, social media applications, news applications, gaming applications, content stores, electronic program guides, and/or the like. Those skilled in the art will appreciate that the signal can be demodulated and/or decoded in a variety of equipment, including the communication terminal 122, a computer, a TV, a monitor, or satellite dish.

The communication terminal 122 can be located at the user location 119. The communication terminal 122 can be configured to communicate with the network 116. The communications terminal 122 can comprise a modem (e.g., cable modem), a router, a gateway, a switch, a network terminal (e.g., optical network unit), and/or the like. The communications terminal 122 can be configured for communication with the network 116 via a variety of protocols, such as internet protocol, transmission control protocol, file transfer protocol, session initiation protocol, voice over internet protocol, and/or the like. For example, for a cable network, the communication terminal 122 can be configured to provide network access via a variety of communication protocols and standards, such as Data Over Cable Service Interface Specification.

The user location 119 can comprise a first access point 123, such as a wireless access point. The first access point 123 can be configured to provide one or more wireless networks in at least a portion of the user location 119. The first access point 123 can be configured to provide access to the network 116 to devices configured with a compatible wireless radio, such as a mobile device 124, the media device 120, the display device 121, or other computing devices (e.g., laptops, sensor devices, security devices). For example, the first access point 123 can provide a user managed network (e.g., local area network), a service provider managed network (e.g., public network for users of the service provider), and/or the like. It should be noted that in some configurations, some or all of the first access point 123, the communication terminal 122, the media device 120, and the display device 121 can be implemented as a single device.

The user location 119 may not be fixed. By way of example, a user can receive content from the network 116 on the mobile device 124. The mobile device 124 can comprise a laptop computer, a tablet device, a computer station, a personal data assistant (PDA), a smart device (e.g., smart phone, smart apparel, smart watch, smart glasses), GPS, a vehicle entertainment system, a portable media player, a combination thereof, and/or the like. The mobile device 124 can communicate with a variety of access points (e.g., at different times and locations or simultaneously if within range of multiple access points). For example, the mobile device 124 can communicate with a second access point 125. The second access point 125 can be a cell tower, a wireless hotspot, another mobile device, and/or other remote access point. The second access point 125 can be within range of the user location 119 or remote from the user location 119. For example, the second access point 125 can be located along a travel route, within a business or residence, or other useful locations (e.g., travel stop, city center, park).

The system 100 can comprise an application device 126. The application device 126 can be a computing device, such as a server. The application device 126 can provide services related to applications. For example, the application device 126 can comprise an application store. The application store can be configured to allow users to purchase, download, install, upgrade, and/or otherwise manage applications. For example, the application device 126 can be configured to allow users to download applications to a device, such as the mobile device 124, communications terminal 122, the media device 120, the display device 121, and/or the like. The application device 126 can run one or more application services to provide data, handle requests, and/or otherwise facilitate operation of applications for the user.

The system 100 can comprise one or more content source(s) 127. The content source(s) 127 can be configured to provide content (e.g., video, audio, games, applications, data) to the user. The content source(s) 127 can be configured to provide streaming media, such as on-demand content (e.g., video on-demand), content recordings, and/or the like. For example, the content source(s) 127 can be managed by third party content providers, service providers, online content providers, over-the-top content providers, and/or the like. The content can be provided via a subscription, by individual item purchase or rental, and/or the like. The content source(s) 127 can be configured to provide the content via a packet switched network path, such as via an internet protocol (IP) based connection. The content can be accessed by users via applications, such as mobile applications, television applications, set-top box applications, gaming device applications, and/or the like. An example application can be a custom application (e.g., by content provider, for a specific device), a general content browser (e.g., web browser), an electronic program guide, and/or the like.

The system 100 can comprise an edge device 128. The edge device 128 can be configured to provide content, services, and/or the like to the user location 119. For example, the edge device 128 can be one of a plurality of edge devices distributed across the network 116. The edge device 128 can be located in a region proximate to the user location 119. A request for content from the user can be directed to the edge device 128 (e.g., due to the location of the edge device and/or network conditions). The edge device 128 can be configured to package content for delivery to the user (e.g., in a specific format requested by a user device), provide the user a manifest file (e.g., or other index file describing segments of the content), provide streaming content (e.g., unicast, multicast), provide a file transfer, and/or the like. The edge device 128 can cache or otherwise store content (e.g., frequently requested content) to enable faster delivery of content to users.

For example, the edge device 128 can receive a plurality of representations of a content item. Each of the plurality of representations corresponds to a version of a same content item (e.g., a same episode of a television show, a same movie). Each of the plurality of representations differs from others of the plurality of representations by one or more attributes, e.g., a different file format, a different bit rate, or a different language. The plurality of representations can be received from a transcoder, a combiner 117, a content source 127, or another component of the system 100. For example, the plurality of representations can be received as a plurality of Universal Datagram Protocol (UDP) packets.

The edge device 128 can divide each of the plurality of representations into a respective plurality of segments. Each of the segments can correspond to a particular duration of content, e.g., one second of content, two seconds of content, or five seconds of content. Each of the segments can be identified using a file name. The file name can include an identifier of the particular representation to which it corresponds. The file name can also include a sequential identifier indicating where, in a sequence of segments, the particular segment lies. For example, the sequential identifier can correspond to an ordinal number or index, also called “number-based addressing.” Thus, the fifth segment for a representation having an identifier of “123” can be named “segment_5_123.ts.” As another example, the sequential identifier can correspond to a start time of the segment, also called “time-based addressing.” For example, given segments of 2.002 seconds in duration (180180 ticks of a 90 KHz clock), the 42nd segment of representation “123” can be named “segment_7567560_123.ts.”

The edge device 128 can then generate a manifest file facilitating access to the respective plurality of segments for each of the plurality of representations. The manifest file can be generated as a tree or other hierarchy of elements. For example, for streaming content using DASH (Dynamic Adaptive Streaming over HTTP), the manifest file can include a Period element that describes a particular duration of the content item, e.g., a duration of the content item bound by a start time and an end time. The Period element can include, as child elements, Representation elements identifying each representation of the content item available during that duration. The Representation elements can describe various attributes of the corresponding representation of the content item, allowing for a user device to select a representation for streaming based on user device capabilities (e.g., display resolution, supported file formats) and available bandwidth. For example, the Representation element “<Representation id=415066 bandwidth=415066 width-320 height=576 framerate=24000/1001 codecs=avc1.4d401f/>” describes a representation having an id “415066,” a bandwidth of 4115066 bits per second, a resolution of 320×576, a framerate of 24 frames per second, and a codec avc1.4d401f

The manifest file can also include parameters or attributes facilitating the generation of requests for segments by a user device. The manifest file can include an explicit list of each segment available for each representation. For example, a Representation element can include, as child elements, a SegmentList element. The SegmentList element can include, as child elements, SegmentURL elements having file names or other identifiers for each segment available for the representation corresponding to its ancestor Representation element. As this approach requires the manifest to explicitly identify each segment for each representation of a content item, the size of the manifest file can grow as the number of representations of a content item increases, or as the duration of the content item increases.

Where the naming convention of segments is predictable, the manifest file can include a template element that includes placeholder parameters. The placeholder parameters can be replaced with real parameters (e.g., a representation identifier, a segment index, and/or a segment start time) by a user device to generate a request for a segment. For example, using DASH, the SegmentTemplate element “<SegmentTemplate media=“$RepresentationID$/$Number$.ts” startNumber=”1 /> includes the “media” attribute. The placeholder parameters “RepresentationID” and “Number” are denoted by being bound by the character “$.” Using this SegmentTemplate element, a user device can generate a request for a particular segment number of a particular representation by replacing the placeholder elements with the respective representation identifier and segment number. For example, to request the fifth segment of representation “123,” the user device would generate a request for “123/5.ts.” The SegmentTemplate element can be included in a same level or higher level in a tree structure of the manifest file. Thus, the SegmentTemplate is applicable to all representations (e.g, Representation elements) encoded at the same or lower levels of the manifest file.

As was set forth above, the edge device 128 can receive a plurality of representations, and then generate, for each of the plurality of representations, a respective plurality of segments. The edge device 128 can determine that at least one segment of the respective plurality of segments is unavailable. For example, the edge device 128 can determine that at least a portion of the one of the plurality of representations corresponding to the at least one segment was not received. As an example, one or more packets of the one of the plurality of representations corresponding to the at least one segment may have been dropped or corrupted during transmission to the edge device 128. In response to determining that the at least one segment is unavailable, the edge device 128 can generate a manifest file comprising a plurality of representation elements (e.g., DASH Representation elements) corresponding to the plurality of representations, wherein one of the plurality of representation elements associated with the at least one segment (e.g., corresponding to the one of the plurality of representations associated with the at least one segment) indicates that the at least one segment is unavailable.

For example, a representation element can include a child element, referred to by example as a GapTimeline element. The GapTimeline element can serve as a parent element to one or more child segment elements (referred to by example as S elements) that identify the unavailable at least one segment. For example:

### <GapTimeline>

<S n=42 r=3/>
<S n=51/>

### </GapTimeline>

This GapTimeline element includes a first child S element indicating that segment number 42 is unavailable. The attribute “r” indicates the number of additional (repeating) segments after segment number 42 that are unavailable. Thus, segments 42, 43, 44, and 45 are identified as being unavailable. The GapTimeline element also includes a second child. S element indicating that segment 51 is unavailable. Although the S elements are depicted as being children of a GapTimeline element, it is understood that the S elements can also be encoded as direct children of representation elements (e.g., DASH Representation elements). As another example, the representation element itself can comprise an attribute indicating the unavailable at least one segment. For example, “<Representation id=415066 bandwidth=415066 width-320 height”576 framerate=24000/1001 codecs=avc1.4d401f gap=42 r=3/>” includes the “gap” attribute 42, indicating that segment 42 of representation 415066 is unavailable. The attribute “r=3” indicates that the three subsequent segments are also unavailable. Thus, segments 42-45 are indicated as unavailable.

The one of the plurality of representation elements associated with the at least one segment indicating that the at least one segment is unavailable can comprise an attribute associated with content displayable by a user device instead of the unavailable at least one segment. For example, the representation element, or a child node thereof, can include an attribute comprising a text string displayable by a user device. Thus, a user device, instead of requesting the unavailable at least one segment, can instead display the text string. The text string can be displayed for a duration corresponding to the duration of the at least one segment, or another duration. For example, the text string can comprise “ERROR,” thereby causing the text string “ERROR” to be displayed by a user device.

As another example, the attribute can comprise a file identifier (e.g., a video file identifier or image file identifier) indicating content to be displayed by the user device instead of the unavailable at least one segment. Thus, instead of generating a request for the unavailable at least one segment, the user device can generate a request for the content corresponding to the file identifier. The content corresponding to the file identifier can then be displayed for the duration of the unavailable at least one segment, or another duration.

This approach, where unavailable segments are identified at the representation level, provides advantages over existing solutions to identify unavailable segments. Existing solutions cause the manifest file to include separate Period elements to identify unavailable segments. For example, assume three representations A, B, and C, and segments 42-45 of representation B being unavailable. Existing solutions would require a manifest including a first Period element for segments 1-41 and including Representation elements for representations A, B, and C, a second Period element for segments 42-45 and including representation elements for representations A and C, and a third Period element for segments 46-end, with Representation elements for representations A, B, and C. As each Period element must include its own set of child elements (e.g., Representation elements), this results in data duplication of identical Representation elements across Period elements, thereby increasing the overall size of the manifest file. If further segment unavailability occurs, the size of the manifest file would further increase as new Period elements are added. In contrast, the approach set forth above allows for unavailable segments to be identified within a same Period element, saving on manifest file size and network traffic used to transmit file sizes to user devices.

A content provider may wish for segment file names to not follow a predictable naming convention. For example, segments templates (e.g., DASH SegmentTemplate elements) using a file naming convention varying only by representation identifier, segment number, and/or segment time code allows for predictable naming of segments. Thus, a user device wishing to request a particular segment for a particular representation need only know the representation identifier, segment number, or segment time code. This can allow for a malicious user to programmatically request segments in order to circumvent or attack forensic watermarking sequences encoded in the representations of the content item.

Segment file names can include additional text strings, e.g., a semirandom or random text string, in order to deviate from predictable naming conventions. However, under existing approaches, this prevents the use of segment templates (e.g., DASH SegmentTemplate elements) for dynamic generation of segment requests by user devices. In these existing approaches, each segment for each representation must be individually listed in the manifest file. Thus, for M representations having N segments, the manifest file must individually list M*N segments.

To reduce manifest file size and use non-predictable naming conventions, the edge device 128 can generate a manifest file comprising a template element (e.g., a DASH SegmentTemplate element). The template element can comprise, as child elements, a plurality of segment elements (e.g., S elements). Each segment element can comprise a respective sequential identifier (e.g., a segment number and a segment start time) and a respective string value. The string value can comprise a plurality of substrings separated by a delimiter character. For example, the string character “2ec5523d-c76b-4934-8bc6-d2558c5c6a49” comprises substrings “2ec5523d,” “c76b,” “4934,” “8bc6,” and “d2558c5c6a49,” separated by the delimiter character “-”. The template element can also comprise a placeholder parameter replaced with at least a portion of the respective string value. For example:

```
<SegmentTemplate media=″$RepresentationID$/$Number$_$VarArg$.ts″
startNumber=″1 />
  <S t=″187680″ n=″1″ d=″180180″ vararg= “2ec5523d-c76b-4934-8bc6-
d2558c5c6a49″/>
  <S n=″2″ d=″180180″ vararg= “11e9953c-db3e-4e32-9dff-
  0200998c070b″/>
  <S n=″3″ d=″180180″ vararg= “5e98ba01-e5cf-44a2-8ea8-
  7b50cfd0196d″/>
...
</SegmentTemplate>
```

In this example, when generating a request for a segment, the $VarArg$ placeholder parameter of the “media” attribute would be replaced with the “vararg” attribute of the corresponding S element. Thus, given a representation identifier of “123,” a request for the first segment would comprise a request for “123/1_2ec5523d-c76b-4934-8bc6-d2558c5c6a49.ts.” Where the respective string value (“vararg”) attribute comprises a plurality of substrings separated by a delimiter character, the placeholder attribute $VarArg$ may further comprise an index identifier, e.g., $VarArg[0]$. The index identifier serves to identify the index of the substring used to generate a request for a segment. For example:

```
<SegmentTemplate media=″$RepresentationID$/
$Number$_$VarArg[0]$.ts″ startNumber=″1 />
  <S t=″187680″ n=″1″ d=″180180″ vararg= “2ec5523d-c76b-4934-8bc6-
d2558c5c6a49″/>
  <S n=″2″ d=″180180″ vararg= “11e9953c-db3e-4e32-9dff-
  0200998c070b″/>
  <S n=″3″ d=″180180″ vararg= “5e98ba01-e5cf-44a2-8ea8-
  7b50cfd0196d″/>
...
</SegmentTemplate>
```

Using the example above, given a representation identifier of “123,” a request for the first segment would comprise a request for “123/1_2ec5523d.ts.”

The edge device 128 can generate the manifest file such that the template element is encoded at a same or higher level as representation elements (e.g., DASH Representation elements), such that each segment element is applicable to all segments of the plurality of representations having a same start time or segment number (e.g., encoding the same portion of content). Thus, for M representations each having N segments, the manifest file would only require N segment entries, as opposed to M*N segment entries as in existing solutions.

The edge device 128 can then transmit the generated manifest file to a user device, e.g., in response to a request for the manifest file. Although the discussion above refers to actions performed by the edge device 128, it is understood that these actions can be performed by another component of the system 100 that generates manifest files to facilitate access to content by user devices.

The network 116 can comprise a network component 129. The network component 129 can comprise any device, module, and/or the like communicatively coupled to the network 116. For example, the network component 129 can comprise a router, a switch, a splitter, a gateway, a encoder, a storage device, a multiplexer, a network access location (e.g., tap), physical link, and/or the like.

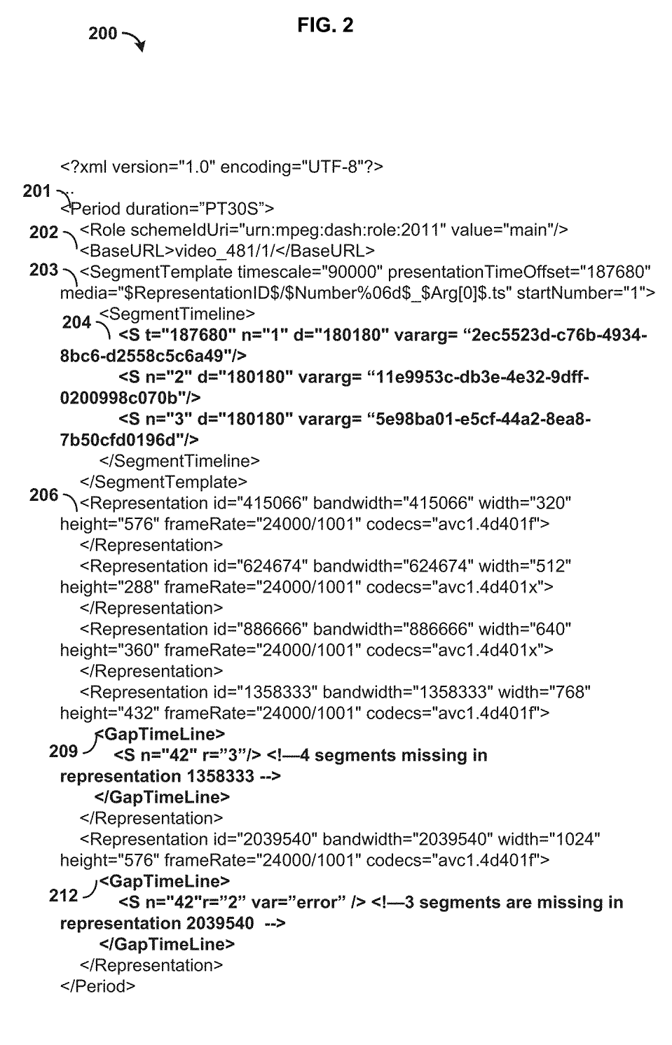

FIG. 2 is an example manifest file 200. The manifest file 200 can correspond to a manifest file 200 generated by an edge device 128 to facilitate access to content by a user device. Although the manifest file 200 is shown as encoded in XML, it is understood that the manifest file 200 can be encoded in other formats. Period element 201 comprises a “duration” parameter of 30 seconds. Thus, all child nodes of the period element 201 serve to describe 30 seconds of a same content item. BaseURL element 202 comprises a text string “video_481/1/” corresponding to a portion of a Uniform Resource Locator (URL). Additional text can be appended to this text string to generate a request for content. For example, a user device having the manifest 200 can generate a request for a segment of the content item by appending additional text to the text string included in the BaseURL element 202. The SegmentTemplate element 203 comprises a “media” attribute that describes placeholder parameters for generating a request for a segment of the content item. For example, placeholder parameters in the “media” attribute will be replaced, e.g., by a user device, with actual parameters describing a particular segment of the content item. Here, the “media” attribute includes placeholder parameters “RepresentationID,” “Number,” and “Arg[0],” indicated in the string “$RepresentationID$/$Number$_$Arg[0]$.ts” and bound by “$” characters. “RepresentationID” corresponds to an identifier of a particular representation of the content item, “Number” corresponds to a sequence number of a segment, and “Arg[0]” corresponds to a first substring in a “vararg” attribute of the segment identified by the “Number” parameter.

S elements 204 describe a segment of the content item. The “n” attribute indicates the sequence number of the segment. The “vararg” attribute comprises a string value comprised of a plurality of substrings separated by the “-” delimiter character. As segments can have file names including a portion of the “vararg” attribute, the file names of segments can vary from a predictable naming convention based solely on representation identifiers, sequence numbers, and/or start times. As S elements 204 are encoded in the manifest 200 at the same hierarchical level as the Representation elements 206, each attribute of a particular S element 204 is applicable to each corresponding segment across the representations of the content item. For example, the attributes of the S element 204 with “n” attribute 1 apply to all first segments of each representation of the content item.

Representation elements 206 describe particular attributes of a representation of the content item. Here, Representation element 206 includes an “id” attribute, serving as a unique identifier, a “bandwidth” attribute indicating the bit rate of segments of the representation, “width” and “height” attributes describing a resolution of the representation, a “frameRate” attribute describing the frame rate of the representation, and a “codec” attribute describing the codec used to encode the representation. By describing multiple representations in the manifest file 200, a user device can select, based on user device capabilities and/or network conditions, a particular representation for requesting segments of the content item.

For example, assume that a user device has selected the representation described by Representation element 206. To generate a request for segment 1 of this representation, the user device can substitute the number 1 and the “id” attribute of the Representation element 206 into the “media” attribute of the SegmentTemplate element 203. The user device can substitute the first substring of the “vararg” attribute of S element 204 into the “media” attribute of the SegmentTemplate element 203, thereby generating a text string “415066/1_2ec5523d-c76b.ts.” This text string, combined with the BaseURL element 202, results in a text string “video_481/1/415066/1_2ec5523d-c76b.ts,” Thus, the user device can transmit, e.g., to the edge device 128, a request for “video_481/1/415066/1_2ec5523d-c76b.ts.”

GapTimeline element 209 indicates that segment 42 of its parent Representation element 206 (having an “id” attribute 1358333) is unavailable. Additionally, GapTimeline element 209 indicates, through the “r” attribute, that the three subsequent elements are also unavailable. Thus, segments 42-45 of representation 1358333 are indicated as unavailable in the manifest 200. GapTimeline element 212 indicates that segment 42 of its parent Representation element 206 (having an “id” attribute 2039540) is unavailable. Additionally, GapTimeline element 212 indicates, through the “r” attribute, that the two subsequent elements are also unavailable. Thus, segments 42-44 of representation 2039540 are indicated as unavailable in the manifest 200. GapTimeline element 212 also includes a “var” attribute comprising a text string displayable by a user device. Thus, instead of requesting any of segments 42-44 for representation 2049540, a user device can display the text string “error.”

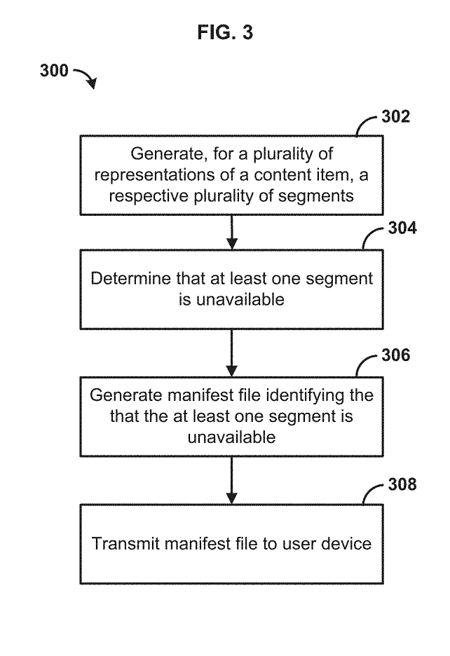

FIG. 3 is a flowchart 300 of an example method. At step 302, for a plurality of representations of a content item, a respective plurality of segments can be generated, e.g., by an edge device 128. Each of the plurality of representations can correspond to a version of a same content item (e.g., a same episode of a television show, a same movie) Each of the plurality of representations can differ from others of the plurality of representations by one or more attributes, e.g., a different file format, a different bit rate, or a different language. The plurality of representations can be received as a plurality of Universal Datagram Protocol (UDP) packets.

Each of the respective plurality of segments can correspond to a particular duration of content, e.g., one second of content, two seconds of content, or five seconds of content. Each of the respective plurality of segments can be identified using a file name. The file name can include an identifier of the particular representation to which it corresponds. The file name can also include a sequential identifier indicating where, in a sequence of segments, the particular segment lies. For example, the sequential identifier can correspond to an ordinal number or index, also called “number-based addressing.” Thus, the fifth segment for a representation having an identifier of “123” can be named “segment_5_123.ts.” As another example, the sequential identifier can correspond to a start time of the segment, also called “time-based addressing.” For example, given segments of 2.002 seconds in duration (180180 ticks of a 90 KHz clock), the 42nd segment of representation “123” can be named “segment_7567560_123.ts,”

At step 304, it can be determined that at least one segment of the respective plurality of segments is unavailable, e.g., by an edge device 128. For example, it can be determined that at least a portion of one of the plurality of representations corresponding to the at least one segment was not received. As an example, one or more packets of the one of the plurality of representations corresponding to the at least one segment may have been dropped or corrupted during transmission, e.g., to the edge device 128. In response to determining that the at least one segment is unavailable, a manifest file can be generated, at step 306, (e.g., by the edge device 128) comprising a plurality of representation elements (e.g., DASH Representation elements) corresponding to the plurality of representations, wherein one of the plurality of representation elements associated with the at least one segment (e.g., corresponding to the one of the plurality of representations associated with the at least one segment) indicates that the at least one segment is unavailable.

For example, a representation element can include a child element, referred to by example as a GapTimeline element. The GapTimeline element can serve as a parent element to one or more child segment elements (referred to by example as S elements) that identify the unavailable at least one segment. For example:

### <GapTimeline>

<S n=42 r=3/>
<S n=51/>

### </GapTimeline>

This GapTimeline element includes a first child S element indicating that segment number 42 is unavailable. The attribute “r” indicates the number of additional (repeating) segments after segment number 42 that are unavailable. Thus, segments 42, 43, 44, and 45 are identified as being unavailable. The GapTimeline element also includes a second child S element indicating that segment 51 is unavailable. Although the S elements are depicted as being children of a GapTimeline element, it is understood that the S elements can also be encoded as direct children of representation elements (e.g., DASH Representation elements). As another example, the representation element itself can comprise an attribute indicating the unavailable at least one segment. For example, “<Representation id=415066 bandwidth=415066 width-320 height=576 framerate=24000/1001 codecs=avc1.4d401f gap=42 r=3/>” includes the attribute 42, indicating that segment 42 of representation 415066 is unavailable. The attribute “r=3” indicates that the three subsequent segments are also unavailable. Thus, segments 42-45 are indicated as unavailable.

The one of the plurality of representation elements associated with the at least one segment indicating that the at least one segment is unavailable can comprise an attribute associated with content displayable by a user device instead of the unavailable at least one segment. For example, the representation element, or a child node thereof, can include an attribute comprising a text string displayable by a user device. Thus, a user device, instead of requesting the unavailable at least one segment, can instead display the text string. The text string can be displayed for a duration corresponding to the duration of the at least one segment, or another duration. For example, the text string can comprise “ERROR,” thereby causing the text string “ERROR” to be displayed by a user device.

As another example, the attribute can comprise a file identifier (e.g., a video file identifier or image file identifier) indicating content to be displayed by the user device instead of the unavailable at least one segment. Thus, instead of generating a request for the unavailable at least one segment, the user device can generate a request for the content corresponding to the file identifier. The content corresponding to the file identifier can then be displayed for the duration of the unavailable at least one segment, or another duration. After generating the manifest, at step 308, the manifest file can be transmitted to a user device (e.g., by the edge device 128).

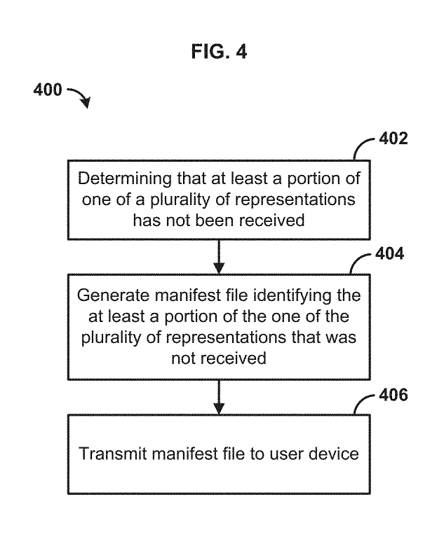

FIG. 4 is a flowchart 400 of an example method. At step 402, it can be determined, e.g., by an edge device 128, that at least a portion of one of a plurality of representations of a content item was not received. As an example, one or more packets of the one of the plurality of representations may have been dropped or corrupted during transmission, e.g., to the edge device 128. Accordingly, determining that the at least a portion of the one of the plurality of representations was not received can include determining one or more sequence numbers or other identifiers of received packets to identify a missing packet. Determining that the at least a portion of the one of the plurality of representations was not received can include calculating a checksum or hash value of one or more packets to determine that the one or more packets were corrupted or otherwise compromised during transmission.

in response to determining that the at least a portion of the one of the plurality of representations was not received, at step 404, a manifest file can be generated (e.g., by the edge device 128) comprising a plurality of representation elements (e.g., DASH Representation elements) corresponding to the plurality of representations, wherein one of the plurality of representation elements indicates that the at least a portion of the one of the plurality of representations was not received. For example, the one of the plurality of representation elements can include a child element, e.g., a GapTimeline element. The GapTimeline element can serve as a parent element to one or more child segment elements (referred to by example as S elements) that identify one or more segments that are unavailable due to the at least a portion of the one of the plurality of representations not being received. For example, the edge device 128 may be unable to generate one or more segments due to the at least a portion of the one of the plurality of representations not being received. These one or more segments would therefore be unavailable to a user device. For example:

### <GapTimeline>

<S n=42 r=3/>
<S n=51/>

### </GapTimeline>

This GapTimeline element includes a first child S element indicating that segment number 42 is unavailable. The attribute “r” indicates the number of additional (repeating) segments after segment number 42 that are unavailable. Thus, segments 42, 43, 44, and 45 are identified as being unavailable. The GapTimeline element also includes a second child S element indicating that segment 51 is unavailable. Although the S elements are depicted as being children of a GapTimeline element, it is understood that the S elements can also be encoded as direct children of representation elements (e.g., DASH Representation elements). As another example, the representation element itself can comprise an attribute indicating that the at least a portion of the one of the plurality of representations was not received. For example, “<Representation id=415066 bandwidth=415066 width-320 height=576 framerate=24000/1001 codecs=avc1.4d401f gap=42 r=3/>” includes the “gap” attribute 42, indicating that segment 42 of representation 415066 is unavailable. The attribute “r=3” indicates that the three subsequent segments are also unavailable. Thus, the Representation element indicates that at least a portion of representation 415066 corresponding to segments 42-45 were not received.

The one of the plurality of representation elements indicating that the at least a portion of the one of the plurality of representations was not received can comprise an attribute associated with content displayable by a user device. For example, the representation element, or a child node thereof, can include an attribute comprising a text string displayable by a user device. Thus, instead of requesting at least one segment associated with the at least a portion of the one of the plurality of representations that was not received, a user device can display the text string. The text string can be displayed for a duration corresponding to the duration of the at least one segment, or another duration. For example, the text string can comprise “ERROR.,” thereby causing the text string “ERROR” to be displayed by a user device.

As another example, the attribute can comprise a file identifier (e.g., a video file identifier or image file identifier) indicating content to be displayed by the user. Thus, instead of generating a request for at least one segment associated with the at least a portion of the one of the plurality of representations was not received, the user device can generate a request for the content corresponding to the file identifier. The content corresponding to the file identifier can then be displayed for the duration of the at least one segment, or another duration. After generating the manifest, at step 406, the manifest file can be transmitted to a user device (e.g., by the edge device 128).

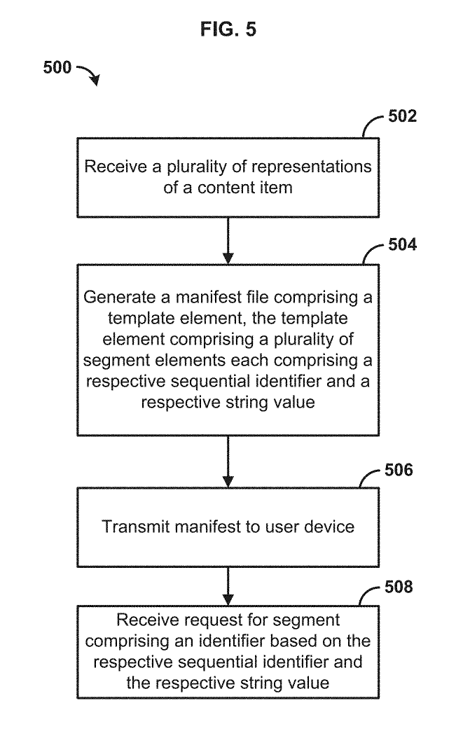

FIG. 5 is a flowchart 500 of an example method. At step 502, a plurality of representations of a content item can be received, e.g., by an edge device 128. Each of the plurality of representations corresponds to a version of a same content item (e.g., a same episode of a television show, a same movie). Each of the plurality of representations differs from others of the plurality of representations by one or more attributes, e.g., a different file format, a different bit rate, or a different language. The plurality of representations can be received from a transcoder, a combiner 117, a content source 127, or another component of the system 100. For example, the plurality of representations can be received as a plurality of Universal Datagram Protocol (UDP) packets.

At step 504, a manifest file comprising a template element (e.g., a DASH SegmentTemplate element) facilitating access to the plurality of representations can be generated, e.g., by the edge device 128. The template element can comprise, as child elements, a plurality of segment elements (e.g., S elements). Each segment element can comprise a respective sequential identifier (e.g., a segment number and a segment start time) and a respective string value. The string value can comprise a plurality of substrings separated by a delimiter character. For example, the string character “2ec5523d-c76b-4934-8bc6-d2558c5c6a49” comprises substrings “2ec5523d,” “c76b,” “4934,” “8bc6,” and “d2558c5c6a49,” separated by the delimiter character “-”. The template element can also comprise a placeholder parameter replaced with at least a portion of the respective string value. For example:

```
<SegmentTemplate media=″$RepresentationID$/$Number$_$VarArg$.ts″
startNumber=″1 />
  <S t=″187680″ n=″1″ d=″180180″ vararg= “2ec5523d-c76b-4934-8bc6-
d2558c5c6a49″/>
  <S n=″2″ d=″180180″ vararg= “11e9953c-db3e-4e32-9dff-
  0200998c070b″/>
  <S n=″3″ d=″180180″ vararg= “5e98ba01-e5cf-44a2-8ea8-
  7b50cfd0196d″/>
...
</SegmentTemplate>
```

In this example, when generating a request for a segment, the $VarArg$ placeholder parameter of the “media” attribute would be replaced with the “vararg” attribute of the corresponding S element. Thus, given a representation identifier of “123,” a request for the first segment would comprise a request for “123/1_2ec5523d-c76b-4934-8bc6-d2558c5c6a49.ts.” Where the respective string value (“vararg”) attribute comprises a plurality of substrings separated by a delimiter character, the placeholder attribute $VarArg$ may further comprise an index identifier, e.g., $VarArg[0]$. The index identifier serves to identify the index of the substring used to generate a request for a segment. For example:

```
<SegmentTemplate media=″$RepresentationID$/
$Number$_$VarArg[0]$.ts″ startNumber=″1 />
  <S t=″187680″ n=″1″ d=″180180″ vararg= “2ec5523d-c76b-4934-8bc6-
d2558c5c6a49″/>
  <S n=″2″ d=″180180″ vararg= “11e9953c-db3e-4e32-9dff-
  0200998c070b″/>
  <S n=″3″ d=″180180″ vararg= “5e98ba01-e5cf-44a2-8ea8-
  7b50cfd0196d″/>
...
</SegmentTemplate>
```

The manifest file can be generated such that the template element is encoded at a same or higher level as representation elements (e.g., DASH Representation elements), such that each segment element is applicable to all segments of the plurality of representations having a same start time or segment number (e.g., encoding the same portion of content). Thus, for M representations each having N segments, the manifest file would only require N segment entries, as opposed to M*N segment entries as in existing solutions.

At step 506, the manifest file can be transmitted, e.g., by the edge device 128, to a user device. At step 508, a request for a segment can be received. The request can comprise an identifier based on the respective sequential identifier and at least a portion of the respective string value. For example, the identifier can comprise a segment number or a start time. As another example, the identifier can comprise a representation identifier. Using the example above, given a representation identifier of “123,” a request for the first segment can comprise a request for “123/1_2ec5523d.ts.”

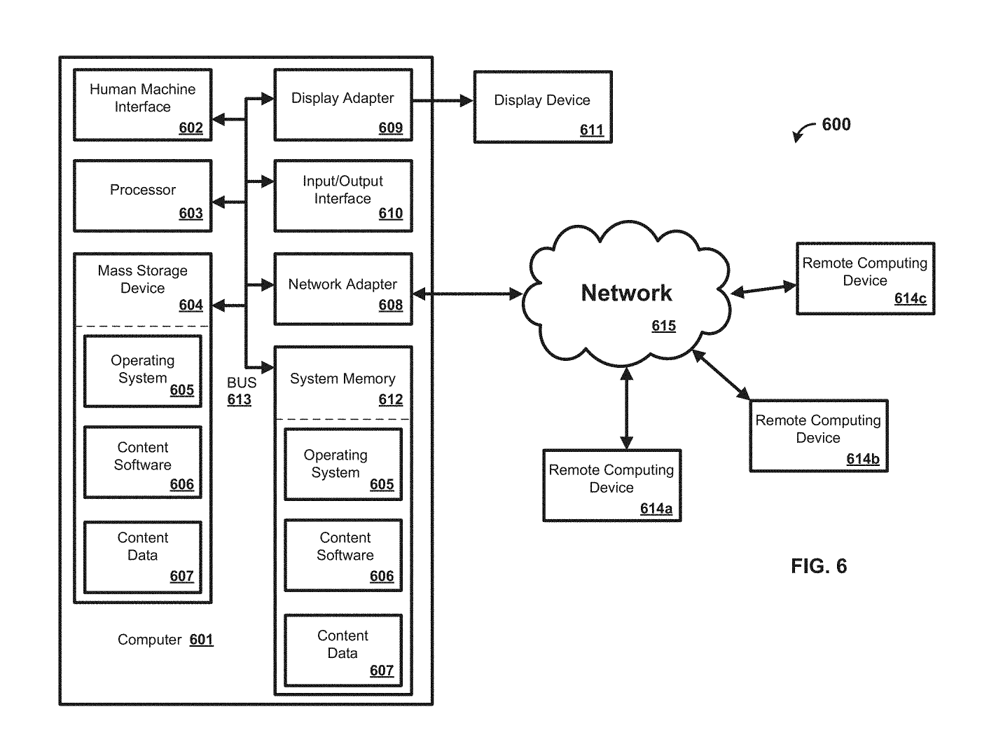

In an aspect, the methods and systems can be implemented on a computer 601 as illustrated in FIG. 6 and described below. By way of example, the server edge device 128 of FIG. 1 can be a computer as illustrated in FIG. 1. Similarly, the methods and systems disclosed can utilize one or more computers to perform one or more functions in one or more locations, FIG. 6 is a block diagram illustrating an operating environment for performing the disclosed methods. This operating environment is only an example of an operating environment and is not intended to suggest any limitation as to the scope of use or functionality of operating environment architecture. Neither should the operating environment be interpreted as having any dependency or requirement relating to any one or combination of components illustrated in the operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 601. The components of the computer 601 can comprise, but are not limited to, one or more processors 603, a system memory 612, and a system bus 613 that couples various system components including the one or more processors 603 to the system memory 612. The system can utilize parallel computing.

The system bus 613 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the one or more processors 603, a mass storage device 604, an operating system 605, content software 606, content data 607, a network adapter 608, the system memory 612, an Input/Output Interface 610, a display adapter 609, a display device 611, and a human machine interface 602, can be contained within one or more remote computing devices 614a,b,c at physically separate locations, connected through buses of this form, in effect implementing a fully distributed system.

The computer 601 typically comprises a variety of computer readable media. Computer readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as the content data 607 and/or program modules such as the operating system 605 and the content software 606 that are immediately accessible to and/or are presently operated on by the one or more processors 603.

In another aspect, the computer 601 can also comprise other removable/non-removable, volatile/non-volatile computer storage media. By way of example, FIG. 6 illustrates the mass storage device 604 which can provide non-volatile storage of computer code, computer readable instructions, data structures, program modules, and other data for the computer 601. For example and not meant to be limiting, the mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, the operating system 605 and the content software 606. Each of the operating system 605 and the content software 606 (or some combination thereof) can comprise elements of the programming and the content software 606. The content data 607 can also be stored on the mass storage device 604. The content data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 603 via the human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, the display device 611 can also be connected to the system bus 613 via an interface, such as the display adapter 609. It is contemplated that the computer 601 can have more than one display adapter 609 and the computer 601 can have more than one display device 611. For example, the display device 611 can be a monitor, an LCD (Liquid Crystal Display), or a projector. In addition to the display device 611, other output peripheral devices can comprise components such as speakers (not shown) and a printer (not shown) which can be connected to the computer 601 via the Input/Output Interface 610. Any step and/or result of the methods can be output in any form to an output device. Such output can be any form of visual representation, including, but not limited to, textual, graphical, animation, audio, tactile, and the like. The display device 611 and computer 601 can be part of one device, or separate devices.

The computer 601 can operate in a networked environment using logical connections to one or more remote computing devices 614a,b,c. By way of example, a remote computing device can be a personal computer, portable computer, smartphone, a server, a router, a network computer, a peer device or other common network node, and so on. Logical connections between the computer 601 and a remote computing device 614a,b,c can be made via a network 615, such as a local area network (LAN) and/or a general wide area network (WAN). Such network connections can be through the network adapter 608. The network adapter 608 can be implemented in both wired and wireless environments. Such networking environments are conventional and commonplace in dwellings, offices, enterprise-wide computer networks, intranets, and the Internet.

For purposes of illustration, application programs and other executable program components such as the operating system 605 are illustrated herein as discrete blocks, although it is recognized that such programs and components reside at various times in different storage components of the computing device 601, and are executed by the one or more processors 603 of the computer. An implementation of the content software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning, Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
generating, for each of a plurality of representations of a content item, a respective plurality of segments;
determining that at least one segment in the respective plurality of segments is unavailable, wherein the at least one segment corresponds to one of the plurality of representations;
generating a manifest file comprising a plurality of representation elements corresponding to the plurality of representations, wherein one of the plurality of representation elements corresponding to the one of the plurality of representations identifies the at least one segment is unavailable; and
transmitting the manifest file to a user device.

2. The method of claim 1, wherein the manifest file comprises an MPEG DASH manifest file.

3. The method of claim 1, further comprising receiving the plurality of representations via a Universal Datagram Protocol (UDP).

4. The method of claim 1, wherein the one of the plurality of representation elements comprises a text string renderable by the user device instead of the at least one segment.

5. The method of claim 1, wherein determining that the at least one segment is unavailable comprises determining that at least a portion of the one of the plurality of representations corresponding to the at least one segment was not received.

6. The method of claim 1, wherein determining that the at least one segment is unavailable comprises determining that at least a portion of the one of the plurality of representations corresponding to the at least one segment is corrupted.

7. A method comprising:
determining, for a plurality of representations of a content item, that at least a portion of one of the plurality of representations has not been received;
generating a manifest file comprising a plurality of representation elements corresponding to the plurality of representations, wherein one of the plurality of representation elements corresponding to the one of the plurality of representations identifies the at least a portion of the one of the plurality of representations that was not received; and
transmitting the manifest file to a user device.

8. The method of claim 7, wherein the manifest file comprises an MPEG DASH manifest file.

9. The method of claim 8, wherein the plurality of representation elements are included in a same Period element of the manifest file.

10. The method of claim 7, wherein the one of the plurality of representation elements corresponding to the one of the plurality of representations identifies the at least a portion of the one of the plurality of representations that was not received as one or more segments of the one of the plurality of representations.

11. The method of claim 7, wherein the one of the plurality of representation elements comprises an attribute associated with content displayable, by the user device, instead of the at least the portion of the one of the plurality of representations.

12. The method of claim 11, wherein the attribute comprises a text string displayable by the user device.

13. The method of claim 11, wherein the attribute comprises an image identifier.

14. A method comprising:
receiving a plurality of representations of a content item;
generating, based at least in part on the plurality of representations, a manifest file, wherein the manifest file comprises a template element facilitating access to the plurality of representations of the content item, wherein the template element comprises a plurality of segment elements, wherein each of the plurality of segment elements comprises a respective sequential identifier and a respective string value;
transmitting, to a user device, the manifest file; and
receiving a request for a segment of one of the plurality of segments, wherein the request comprises an identifier based on the respective sequential identifier and at least a portion of the respective string value.

15. The method of claim 14, wherein the template element further comprises a Uniform Resource Locator (URL) template comprising a first variable corresponding to the respective sequential identifier and a second variable corresponding to the respective string value.

16. The method of claim 14, wherein the respective string value comprises a plurality of substrings separated by a delimiter character.

17. The method of claim 16, wherein the template element further comprises a Uniform Resource Locator (URL) template comprising an index identifier facilitating a selection of one of the plurality of substrings.

18. The method of claim 17, wherein a wherein the URL template further comprises a third variable corresponding to a variant identifier.

19. The method of claim 14, further comprising:
determining that at least a portion of one of the plurality of representations has not been received; and
wherein generating the manifest file comprises generating the manifest file comprising a plurality of representation elements corresponding to the plurality of representations, wherein the one of the plurality of representation elements corresponding to the one of the plurality of representations identifies the at least a portion of the one of the plurality of representations that was not received.

20. The method of claim 14, wherein the plurality of representation elements are included in a same Period element of the manifest file.
